(19) United States
(12) Patent Application Publication
(10) Pub. No.: US 2026/0267271 A1
(43) Pub. Date: Sep. 10, 2026

(54) IMAGE FORMING APPARATUS

(71) Applicant: KONICA MINOLTA, INC., Tokyo (JP)

(72) Inventors: Takaaki NAMIKI, Aichi (JP); Takeru KINOSHITA, Tokyo (JP)

(73) Assignee: KONICA MINOLTA, INC., Tokyo (JP)

(21) Appl. No.: 19/555,531

(22) Filed: Mar. 3, 2026

(30) Foreign Application Priority Data
Mar. 6, 2025 (JP) 2025-035690

(51) Int. Cl. G03G 15/00; G03G 21/16

(52) U.S. Cl. CPC G03G 15/6511; G03G 21/1638; G03G 2215/00544

(57) ABSTRACT

Provided is an image forming apparatus including: a first rotator; and a second rotator that comes into pressure contact with the first rotator, where the second rotator and the first rotator hold a recording medium between the second rotator and the first rotator to convey the recording medium. The first rotator is detachable, after a pressure contact state between the first rotator and the second rotator is released, to a conveyance side and in a direction different from a direction in which the pressure contact is released.

### CROSS REFERENCE TO RELATED APPLICATIONS

The entire disclosure of Japanese Patent Application No. 2025-035690, filed on March 6, 2025, is incorporated herein by reference in its entirety.

### BACKGROUND

### Technological Field

The present invention relates to a sheet feed apparatus and an image forming apparatus including the sheet feed apparatus, and in particular relates to an image forming apparatus which feeds out sheets mounted and stacked in an apparatus main body one by one.

### Description of Related Art

In the related art, an image forming apparatus of an electrophotographic method, such as a copier or a printer, usually includes a sheet feed apparatus that feeds sheets, which are stacked and stored in a sheet feed cassette, to an image former one by one from the topmost sheet (see, for example, Japanese Patent Publication Laid-Open No. 2011-42416).

The sheet feed apparatus includes: a pick roller; a sheet feed roller; and a sorting roller that comes into pressure contact with the sheet feed roller, and the pick roller sends the topmost sheet that is brought into pressure contact with the pick roller by the own weight of the pick roller to a nip between the sheet feed roller and the sorting roller, holds the sheet at the nip, and feeds out the sheet to an image former.

In Japanese Patent Publication Laid-Open No. 2011-42416, the nip is formed by the sorting roller being pressed by a spring from below the sheet feed roller. The sorting roller applies a brake by a torque limiter for sheet separation, thereby sorting sheets, which are introduced into the nip, one by one.

The sorting roller suffers from a severe wear due to pressing by a spring and a braking operation and deteriorates over time, such as in a case where the surface itself of the sorting roller is clogged with sheet dust and slips, and the sorting roller therefore requires periodic maintenance and inspection as well as periodic replacement. For this reason, various structures that facilitate the detachment of the sorting roller have been considered for image forming apparatuses.

In Japanese Patent Publication Laid-Open No. 2011-42416, a sheet feed unit including a sheet feed roller and a pick roller; and a separation unit including a sorting roller and a turn guide member are separated, and the separation unit is attached to the right side of the sheet feed unit so as to be pivotable around a shaft in a lower portion of the separation unit. An opening-closing door that covers the separation unit is provided on the right side surface side of the separation unit. When the sorting roller is replaced, the opening-closing door is pulled to the right, whereby the separation unit is separated from the sheet feed unit and is exposed to the outside of the apparatus. Along with this, the sorting roller is separated from the sheet feed roller and is exposed to the outside, and is in a state of being replaceable through an opening opened between the sheet feed unit and an opening-closing unit.

However, in the image forming apparatus described in Japanese Patent Publication Laid-Open No. 2011-42416, along with a separation operation of the separation unit from the sheet feed unit by an operation of the opening-closing door, the sorting roller is forcibly moved with an arc-shaped trajectory so as to be separated toward the right side while pressing the sheet feed roller upward with which the sorting roller is in contact at an upper portion thereof.

That is, when the sorting roller is replaced, the sorting roller moves in the right direction in which the sorting roller is separated from the sheet feed roller, while the sorting roller is moving in a pressure contact direction in which the sorting roller comes into pressure contact with the sheet feed roller, as the separation unit moves. Thus, the sorting roller is configured to be detached from the sheet feed roller while applying a load to the sheet feed roller, which may damage the sheet feed roller.

### SUMMARY

An object of the present invention is to provide an image forming apparatus that allows a rotator such as a sorting roller to be easily and suitably replaced.

In order to achieve at least one of the above-described objects, an image forming apparatus reflecting one aspect of the present invention includes:

a first rotator; and

a second rotator that comes into pressure contact with the first rotator, where the second rotator and the first rotator hold a recording medium between the second rotator and the first rotator to convey the recording medium.

The first rotator is detachable, after a pressure contact state between the first rotator and the second rotator is released, to a conveyance side and in a direction different from a direction in which the pressure contact is released.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is an appearance perspective view of an image forming apparatus including a sheet feed apparatus according to an embodiment of the present invention;

FIG. 2 is a conceptual diagram illustrating the inner configuration of the image forming apparatus including the sheet feed apparatus according to an embodiment of the present invention;

FIG. 3 is a block diagram illustrating a main configuration of a control system of the image forming apparatus according to the embodiment;

FIG. 4 is a schematic vertical cross-sectional view of a sheet feed mechanism, which schematically illustrates a positional relationship among respective rollers in a sheet passing state in the sheet feed apparatus according to an embodiment of the present invention;

FIG. 5 is a perspective diagram illustrating an example of a pick roller unit of the sheet feed apparatus according to the embodiment of the present invention;

FIG. 6 is a partially enlarged bottom diagram illustrating the configuration of a main part of the pick roller unit;

FIG. 7 is a schematic vertical cross-sectional view of the sheet feed mechanism, which schematically illustrates a positional relationship among the respective rollers in a replaceable state in the sheet feed apparatus illustrated in FIG. 4;

FIG. 8 is a side view of a pick holder that holds the pick roller unit illustrated in FIG. 7 in a removable state;

FIG. 9 is a perspective view of a sorting unit illustrated in FIG. 4;

FIG. 10 is a perspective view of a sorting roller through which a rotation shaft is inserted;

FIG. 11 is a side view of a sorting holder to which the sorting unit is attached;

FIG. 12 is a diagram illustrating the sheet feed mechanism including the pick roller unit and the sorting unit with a cover removed at an X portion in FIG. 1;

FIG. 13 is an enlarged view of the sorting holder to which the sorting unit is attached in FIG. 12; and

FIG. 14 is a perspective view of the sorting unit in a replaceable state in the X portion of FIG. 1.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present invention will be described in detail with reference to the accompanying drawings.

### Image Forming Apparatus

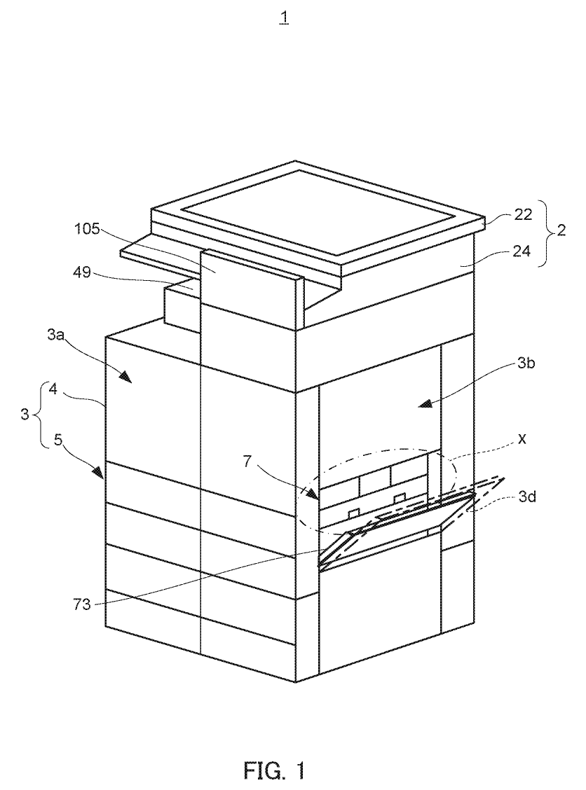

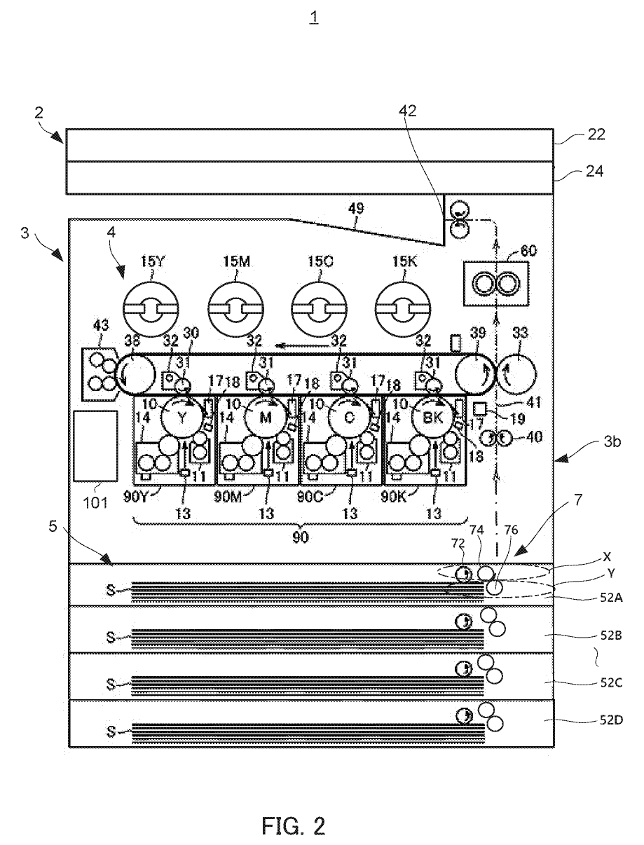

FIG. 1 is an appearance perspective view of an image forming apparatus including a sheet feed apparatus according to an embodiment of the present invention, and FIG. 2 is a conceptual diagram illustrating the inner configuration of the image forming apparatus including the sheet feed apparatus according to an embodiment of the present invention.

An image forming apparatus 1 illustrated in FIGS. 1 and 2 is a color printer utilizing an electrophotographic process technology, that is, the image forming apparatus 1 as a color image forming apparatus is illustrated. Note that, the image forming apparatus 1 has been described as a color printer, but is not limited to a color printer. For example, the image forming apparatus 1 may be a monochrome printer or a multifunction peripheral (so-called Multi Functional Peripheral (MFP)) of a monochrome printer or a color printer and a facsimile.

The image forming apparatus 1 includes a scanner 2 as an image reader and an apparatus main body 3 that functions as a printer.

The scanner 2 is provided on top of the apparatus main body 3. The image forming apparatus 1 includes an image former 4, a sheet feed apparatus 5, and a fixing device 60 as a fixer inside the apparatus main body 3.

The image forming apparatus 1 is configured to convey sheets S one by one from the sheet feed apparatus 5, to form a color image or a monochrome image on a sheet S by the image former 4 and the fixing device 60, and to discharge the sheet S onto a sheet discharge tray 49 from a discharge port 42 in an upper portion of the image forming apparatus 1. The sheet S is an example of a recording medium.

In addition, the image forming apparatus 1 includes a controller 101 inside the apparatus main body 3. The controller 101 controls the operation of each section (device) such as the sheet feed apparatus 5, the image former 4, and the fixing device 60. In addition, as will be described later, the controller 101 controls the operation of a sheet feed mechanism 7 provided in the sheet feed apparatus 5. Note that, details of the sheet feed apparatus 5 will be described later.

The scanner 2 includes: a cover 22 including a tray and an auto document feeder (ADF); and a sheet table 24. One end of the cover 22 is pivotably fixed to the sheet table 24, and the cover 22 is configured to be openable and closable with the one end as a fulcrum. The operator can set a document on the sheet table 24 by opening the cover 22.

When the image forming apparatus 1 receives a scanning instruction in a state in which a document is set on the sheet table 24, the image forming apparatus 1 starts scanning the document set on the sheet table 24. In addition, when the image forming apparatus 1 receives a scanning instruction in a state in which documents are set in the tray, the image forming apparatus 1 automatically reads the documents one by one by the ADF.

The apparatus main body 3 includes image creators 90Y, 90M, 90C, and 90K, an image density control (IDC) sensor 19, a transfer belt 30, and primary transfer rollers 31. Further, the apparatus main body 3 includes transfer drivers 32, a secondary transfer roller 33, trays 52A to 52D, a driven roller 38, a drive roller 39, timing rollers 40, and a cleaning unit 43.

The image creators 90Y, 90M, 90C, and 90K are sequentially arranged along the transfer belt 30. The image creator 90Y receives supply of toner from a toner bottle 15Y to form a yellow (Y) toner image.

The image creator 90M receives supply of toner from a toner bottle 15M to form a magenta (M) toner image. The image creator 90C receives supply of toner from a toner bottle 15C to form a cyan (C) toner image.

The image creator 90K receives supply of toner from a toner bottle 15K to form a black (BK) toner image. The image creators 90Y, 90M, 90C, and 90K are arranged along the transfer belt 30 in the order of the rotation direction of the transfer belt 30.

Each of the image creators 90Y, 90M, 90C, and 90K includes: a photoreceptor 10 that is rotatably configured; a charging apparatus 11; an exposure apparatus 13; a developing device 14; a cleaning unit 17; and a toner sensor 18.

After the respective image creators 90Y, 90M, 90C, and 90K operate as described above, a yellow (Y) toner image, a magenta (M) toner image, a cyan (C) toner image, and a black (BK) toner image are sequentially superposed by transfer of the transfer driver 32. Then, the toner images are transferred from photoreceptor 10 onto transfer belt 30, and a color toner image is formed on the transfer belt 30.

The IDC sensor 19 detects the density of a toner image to be formed on the transfer belt 30. The IDC sensor 19 is, for example, a light intensity sensor composed of a reflection-type sensor, and detects the intensity of reflected light from the surface of the transfer belt 30.

The transfer belt 30 is stretched around the driven roller 38 and the drive roller 39. The drive roller 39 is connected to a motor (not illustrated). By controlling this motor (not illustrated), the drive roller 39 rotates.

The transfer belt 30 and the driven roller 38 rotate in conjunction with the drive roller 39. Thus, the toner image on the transfer belt 30 is sent to the secondary transfer roller 33. Sheets of different sizes are set in the trays 52A to 52D, respectively.

The sheet S is an example of a recording medium. Sheets S are conveyed one by one from any of the trays 52A to 52D of the sheet feed apparatus 5 to the timing roller 40 via the sheet feed mechanism 7. Then, the sheets S are conveyed to the secondary transfer roller 33 along a conveyance route 41 by the timing roller 40. The transfer voltage to be applied to the secondary transfer roller 33 is controlled in line with the timing with which the sheet S is fed out.

The secondary transfer roller 33 applies a transfer voltage, which has a polarity opposite to the polarity to which the toner image is charged, to the sheet S during conveyance. As a result, the toner image is attracted from the transfer belt 30 to the secondary transfer roller 33, and the toner image on the transfer belt 30 is transferred.

The timing of conveyance of the sheet S to the secondary transfer roller 33 is controlled by the timing roller 40 in line with the position of the toner image on the transfer belt 30. As a result, the toner image on the transfer belt 30 is transferred onto a suitable position of the sheet S. The fixing device 60 applies pressure and heat to the sheet S passing through the fixing device 60.

Thus, the toner image is fixed onto the sheet S. Thereafter, the sheet S is discharged to the sheet discharge tray 49. The cleaning unit 43 collects toner remaining on the surface of the transfer belt 30 after the toner image is transferred from transfer belt 30 onto the sheet S. The collected toner is conveyed by a conveyance screw (not illustrated) and is stored in a waste toner container (not illustrated).

### Control System

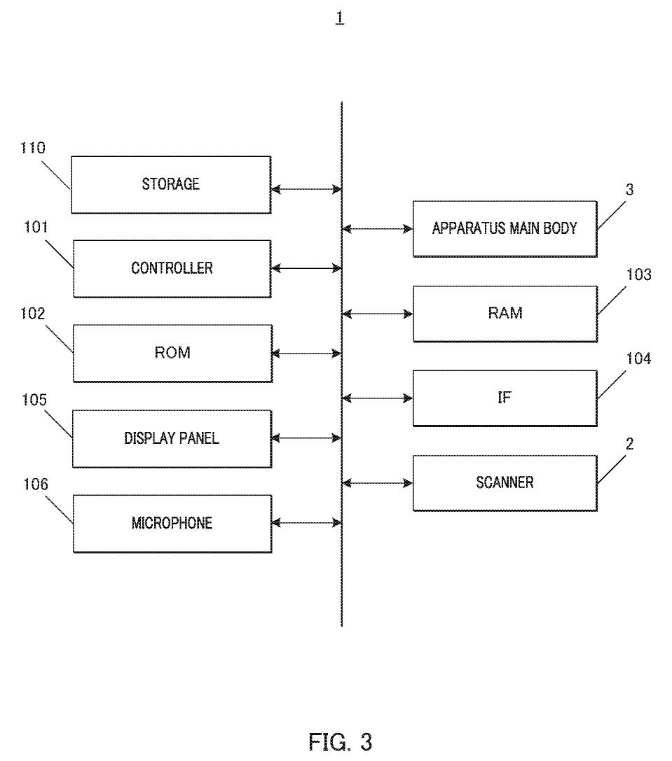

FIG. 3 is a block diagram illustrating a main configuration of a control system of the image forming apparatus 1 according to the embodiment. An example of a main hardware configuration of the control system of the image forming apparatus 1 will be described with reference to FIG. 3.

The image forming apparatus 1 includes the controller 101, a read only memory (ROM) 102, and a random access memory (RAM) 103 in addition to the scanner 2 and the apparatus main body 3. The image forming apparatus 1 further includes a network interface (“IF”) 104, a display panel 105, a microphone 106, and a storage 110.

The controller 101 is constituted by at least one integrated circuit, for example, and the integrated circuit is constituted by at least one central processing unit (CPU), for example. Note that, the controller 101 may also be constituted by at least one application specific integrated circuit (ASIC). In addition, the controller 101 may also be constituted by at least one field programmable gate array (FPGA). In addition, the controller 101 may also be constituted by a combination of a CPU, an ASIC, and an FPGA, or the like.

The controller 101 reads various programs, such as a control program for adjusting control parameters of the image forming apparatus 1, from the storage 110 and executes the various programs to control the operation of the image forming apparatus 1.

The controller 101 reads the control program from the storage 110 to the RAM 103 based on the reception of an execution command of the control program. The RAM 103 functions as a working memory and temporarily stores various types of information necessary for executing the control program.

An antenna (not illustrated), a wireless module, and the like are connected to the network interface (“IF”) 104. The image forming apparatus 1 exchanges data with an external communication device via the antenna and the wireless module. The external communication device may be, for example, a portable communication terminal such as a smartphone, a server, or the like. The control program may be configured to be downloadable from a server via the antenna.

The display panel 105 is constituted by a display and a touch screen. The display and the touch screen are overlaid on each other, and receive an operation on the image forming apparatus 1 by a touch operation. In addition, the display panel 105 can not only receive a setting operation but also provide a user with various types of information.

The storage 110 is, for example, an HDD, a solid state drive (SSD), or any other storage. The storage 110 may be either of a built-in type or of an external type. The storage 110 stores the control program according to the present embodiment, and the like. However, the storage location of the control program is not limited to the storage 110, and the control program may also be stored in a storage region (for example, a cache) of the controller 101, the ROM 102, the RAM 103, an external device (for example, a server), or the like.

The control program may not be provided as a single program but may also be provided by being incorporated in a part of an arbitrary program. In this case, the control processing according to the present embodiment is realized in cooperation with the arbitrary program. Even a program that does not include such some modules does not depart from the spirit of the control program according to the present embodiment. Further, some or all of the functions provided by the control program may be implemented by dedicated hardware. Further, the image forming apparatus 1 may be configured in a form such as a so-called cloud service in which at least one server executes a part of the processing of the control program. The microphone 106 receives an input of sound.

The sheet feed apparatus 5 includes, for each of the trays 52A to 52D, the sheet feed mechanism 7 that supplies a sheet from each tray to the conveyance route 41. That is, the sheet feed apparatus 5 may include suppliers of the sheet, which are of four stages and are the trays 52A to 52D, and each of these suppliers may include a first rotator (sorting roller 76) to be described later and a second rotator (sheet feed roller 74) to be described later. The sheet feed apparatus 5 may include one-stage to four-stage suppliers of the sheet, and each of the suppliers may include the sheet feed roller 74 and the sorting roller 76.

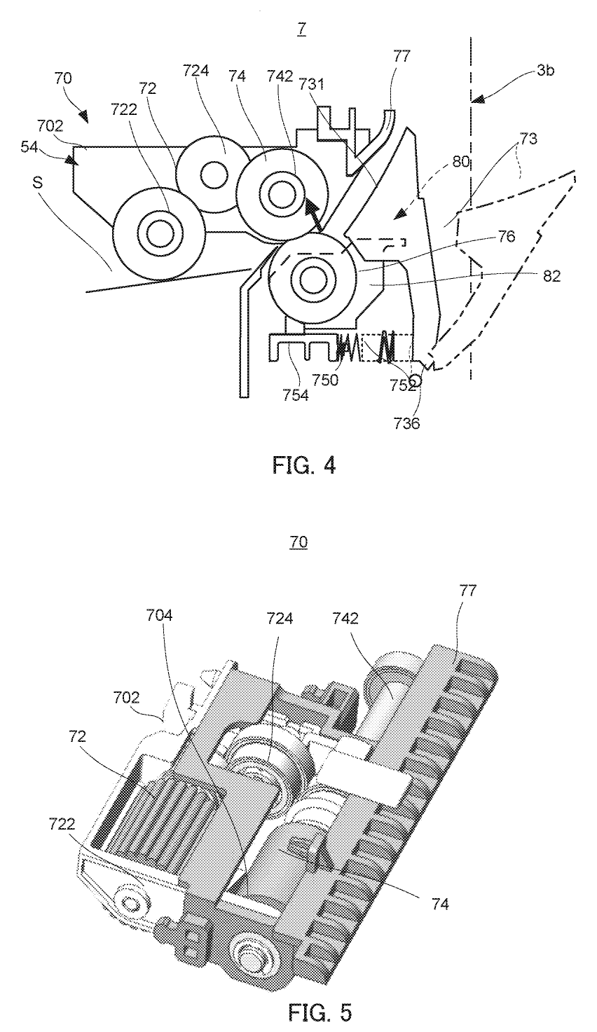

FIG. 4 is a schematic vertical cross-sectional diagram schematically illustrating a positional relationship among respective rollers in a sheet passing state in the sheet feed apparatus according to an embodiment of the present invention, which corresponds to an X portion of FIG. 1.

The sheet feed mechanism 7 includes: a pick roller 72 that feeds a sheet stored in the trays 52A to 52D; the sheet feed roller 74 that conveys the sheet S fed by the pick roller 72 into the main body; and the sorting roller (first rotator) 76 that sorts the sheet S to be conveyed into the main body.

The pickup roller (hereinafter referred to as the “pick roller”) 72, the sheet feed roller 74 (the second rotator), and the sorting roller 76 are disposed to be rotatable around shafts parallel to each other. The sheet feed mechanisms 7 have a function of, in a case where two or more sheets S are fed out together by the pick roller 72, separating only the topmost sheet S and feeding the separated topmost sheet S to the downstream side in cooperation with each other.

The pick roller 72 is a roller that picks a sheet S from the top of a stack of sheets S stored in the trays 52A to 52D and conveys the sheet S toward the conveyance route 41 in the apparatus main body 3.

The pick roller 72 is driven to rotate together with the sheet feed roller 74 by using a sheet feed motor (not illustrated) as a drive source. For example, the pick roller 72 is in contact with a sheet S located on the topmost surface of a stack of sheets S, and is driven to rotate by a motor (not illustrated) in the direction (counterclockwise direction) indicated by the arrow in FIG. 2. That is, the pick roller 72 is driven to rotate as the sheet feed operation is started in the image forming apparatus 1, and feeds out the sheet S, which is located on the topmost surface, to the downstream side.

The sheet feed roller 74 and the sorting roller 76 are disposed on the downstream side of the pick roller 72. The sheet feed roller 74 and the sorting roller 76 are rollers that form a pair thereof.

The sheet feed roller 74 conveys the sheet S fed by the pick roller 72 into the apparatus main body 3.

The sheet feed roller 74 is located above the conveyance route 41, and is driven to rotate by a motor (not illustrated) in the direction (counterclockwise direction) indicated by the arrow in FIG. 2 in the same manner as with the pick roller 72. The sheet feed roller 74 comes into pressure contact with the sorting roller 76, and the sheet feed roller 74 and the sorting roller 76 hold the sheet S therebetween to convey the sheet S.

The sorting roller 76 sorts the fed sheets S such that the number of sheets S to be conveyed into the apparatus main body 3 does not become two or more. The sorting roller 76 is provided to face the sheet feed roller 74, and a sheet feed nip is formed between the sheet feed roller 74 and the sorting roller 76. The sheet feed roller 74 and the sorting roller 76 that are located at positions forming a sheet feed nip for nipping the fed sheet will be referred to as a nip.

Note that, a sheet feed sensor is disposed downstream of a sheet feed nip formed by the sheet feed roller 74 and the sorting roller 76, and the sheet feed sensor detects that the fed sheet has been fed into the apparatus main body 3. In addition, a conveyance sensor (not illustrated) which detects that the fed sheet S has reached a predetermined position in the apparatus main body 3 is provided downstream of the sheet feed sensor (not illustrated).

The sorting roller 76 rotates in a driven manner by the rotation of the sheet feed roller 74. Having said that, the sorting roller 76 is configured such that the rotation shaft thereof generates a constant friction force against the bearing. For this reason, when the sheet feed roller 74 rotates the sorting roller 76 in a driven manner, the sorting roller 76 is rotated in a driven manner against the frictional force.

Here, in the sheet feed mechanism 7, the pick roller 72 and the sheet feed roller 74 are integrally provided as a pick roller unit 70 such that the pick roller unit 70 is attachable to and detachable from the apparatus main body 3. In addition, the sorting roller 76 is attached as a sorting unit 80 to the apparatus main body 3 such that the sorting unit 80 is attachable to and detachable from the apparatus main body 3.

The sorting roller 76 is configured to be detachable, after the pressure contact state between the sorting roller 76 and the sheet feed roller 74 is released, to a conveyance side and in a direction different from a direction in which the pressure contact is released, where the conveyance side is the right side, and the direction different from the direction in which the pressure contact is released is toward one side of the apparatus main body 3.

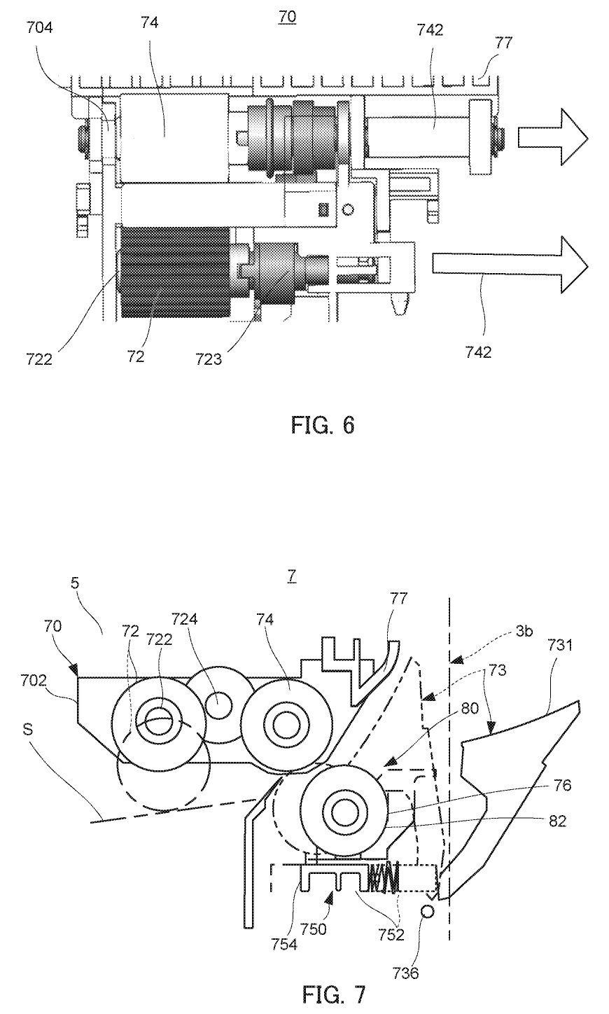

FIG. 5 is a perspective diagram illustrating an example of the pick roller unit 70, and FIG. 6 is a partially enlarged bottom diagram illustrating the configuration of a main part of the pick roller unit 70.

The pick roller unit 70 rotatably supports the pick roller 72 and the sheet feed roller 74 around the shafts parallel to each other such that the respective lower portions of the pick roller 72 and the sheet feed roller 74 are exposed to the outside.

A second supporter 704 pivotably supports the sheet feed roller 74 such that the lower portion of the sheet feed roller 74 is exposed to the outside. As illustrated in FIGS. 5 and 6, the pick roller unit 70 includes: a first supporter 702 that pivotably supports the pick roller 72 around a rotation shaft 722; and the second supporter 704 that rotatably supports the sheet feed roller 74 around a rotation shaft 742.

A holder shaft 724 parallel to the rotation shafts 722 and 742 is provided between the first supporter 702 and the second supporter 704. The holder shaft 724 is supported by the pick roller unit 70 being disposed adjacent to a pick holder 54 in the shaft direction, and functions as a pivoting shaft of the first supporter 702 in response to the operation of the pick holder 54.

The first supporter 702 is formed in a frame shape surrounding the pick roller 72 and including both side walls that support the rotation shaft 722 on the both sides of the pick roller 72. The second supporter 704 is formed in a frame shape including: the holder shaft 724; and arms which face each other and between which the rotation shaft 742 parallel to the holder shaft 724 is provided.

The first supporter 702 and the second supporter 704 form a frame having a rectangular frame shape (frame-shaped supporter). The frame (frame-shaped supporter) pivotably supports the pick roller 72 and the sheet feed roller 74, which are disposed therein, around the rotation shafts 722 and 742. That is, the pick roller 72 and the sheet feed roller 74 are disposed inside the frame-shaped supporter which is the frame formed by the first supporter 702 and the second supporter 704. The pick roller 72 and the sheet feed roller 74 form the pick roller unit 70 that is an integral pick roller unit and is pivotably supported by the frame-shaped supporter via each of the rotation shafts 722 and 742. Each of the rotation shafts 722 and 742 of the pick roller 72 and the sheet feed roller 74 is provided in the frame-shaped supporter to be insertable into and pullable from the frame-shaped supporter.

With respect to the pick roller unit 70, the first supporter 702 is inserted into and pulled from the pick holder 54 of the apparatus main body 3 from the side of a right side surface 3b of the apparatus main body 3, that is, in the horizontal direction orthogonal to the extending direction of each shaft. When the pick roller unit 70 is accommodated in the apparatus main body 3, the pick roller 72, the sheet feed roller 74, and the sorting roller 76 can be arranged at the positions illustrated in FIG. 4.

That is, the pick roller unit 70 and the sorting unit 80 are disposed at the right side surface 3b of the apparatus main body 3 such that the sheet feed roller 74 and the sorting roller 76 are located at the nip position.

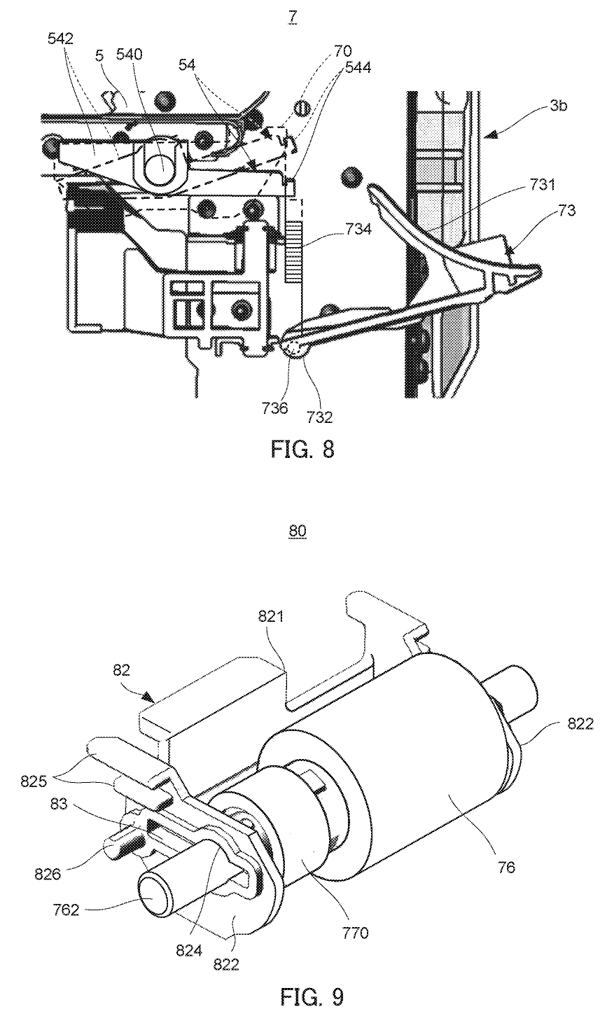

FIG. 7 is a schematic vertical cross-sectional diagram view of the sheet feed mechanism, which schematically illustrates a positional relationship among the respective rollers in a replaceable state in the sheet feed apparatus illustrated in FIG. 4, and FIG. 8 is a side view of a pick holder that holds the pick roller unit illustrated in FIG. 7 in a removable state.

As illustrated in FIG. 7, in a state in which a conveyance guide 73 is inclined outward and the sheet feed mechanism 7 is caused to face the right side surface of the apparatus main body 3, the pick roller 72 in the pick roller unit 70 is separated from the sheet S and the sorting roller 76 is disposed at a position separated from the sheet feed roller 74 in the pick roller unit 70.

The pick roller unit 70 is accommodated in a state of being held by the pick holder 54 (see FIG. 8) in the apparatus main body 3.

The pick holder 54 is disposed adjacent to the pick roller unit 70 in the shaft direction in the apparatus main body 3 and holds the pick roller unit 70. The pick holder 54 is rotatably provided around a rotation shaft 540 parallel to each shaft. The rotation shaft 540 is coaxial with the rotation shaft 742 of the sheet feed roller 74.

The pick holder 54 includes a swing arm 542 extending in one direction from the rotation shaft 540, and a leading-end side of the swing arm 542 is connected to the pick roller 72 or the first supporter 702. The swing arm 542 is disposed so as to be adjacent to the pick roller unit 70 in the shaft direction, and is connected to the pick roller unit 70.

In the pick holder 54, an arm 544 extending in the other direction from the rotation shaft 540 is connected to the conveyance guide 73 via a biasing member 734, for example, a tension spring.

As illustrated in FIG. 7, when the conveyance guide 73 moves in the opening direction, the pick holder 54 pivots around the rotation shaft 540 in conjunction with the movement of the conveyance guide 73, and the swing arm 542 swings (here, rises). Following the swinging of the swing arm 542, the pick roller 72 or the first supporter 702 is moved. Specifically, when the swing arm 542 moves from the position indicated by the broken line to the position indicated by the solid line, the pick roller 72 moves, as illustrated in FIG. 7, from the position indicated by the broken line at which the pick roller 72 abuts on the sheet S to the position indicated by the solid line, that is, the position where the pick roller 72 is separated from the sheet S.

The pick holder 54 supports the pick roller 72 such that the pick roller 72 is movable between a conveyance position, where the pick roller 72 is lowered to a position where the pick roller 72 comes into contact with the sheet S, and a separated position, where the pick roller 72 is separated from the sheet S, during supply of the sheet S. The pick holder 54 is biased to the conveyance position by the biasing member 734 which couples one end of an arm of the sheet feed roller 74, where the arm rotates around the rotation shaft 742 of the sheet feed roller 74, to one end of the conveyance guide 73. The pick roller 72 moves to the separated position by the conveyance guide 73 moving and being separated from a main body-side conveyor 77.

The conveyance guide (outside conveyor) 73 is provided to be pivotable around a shaft 736 with respect to the sheet feed mechanism 7 or the apparatus main body 3 so as to open and close right-side openings of the apparatus main body 3 and the sheet feed apparatus 5. The conveyance guide 73 is operated by a user. In a closed state, the conveyance guide 73, a conveyance surface 731, and the main body-side conveyor 77 that faces the conveyance surface 731 constitute a conveyor. Note that, the main body-side conveyor 77 is provided in the pick roller unit 70. The main body-side conveyor 77 is provided as a part of the pick roller unit 70 to be attachable to and detachable from the apparatus main body 3 by a user operation.

The conveyance guide 73 moves so as to be separated from the main body-side conveyor 77 and is opened to the outside to release the pressure contact state between the pick roller 72 and the sheet S. In a case where the conveyance guide 73 is located at a position where the conveyance guide 73 and the main body-side conveyor 77 form a conveyance path, the conveyance guide 73 presses the pick roller 72 against the sheet S to establish a sheet passing state. In addition, the conveyance guide 73 moves so as to be separated from the main body-side conveyor 77 and is opened to the outside to release the pressure contact state between the sorting roller 76 and the sheet feed roller 74. In a case where the conveyance guide 73 is located at a position where the conveyance guide 73 and the main body-side conveyor 77 form a conveyance path, the conveyance guide 73 presses the sorting roller 76 against the sheet feed roller 74 to establish a sheet passing state.

The conveyor conveys the sheet S, which is discharged from the nip including the sheet feed roller 74 and the sorting roller 76, to the conveyance route 41. Note that, the conveyance guide 73 of the conveyor may also include an apparatus cover 3d that covers the conveyance guide 73 from the outer surface. The conveyance guide 73 and the apparatus cover 3d correspond to the outside conveyor.

As described above, in the apparatus main body 3, in a state in which the pick roller unit 70 is accommodated in the pick holder 54, the pick roller 72 is located at a predetermined position, that is, a position where the pick roller 72 comes into contact with the sheet S located on the topmost surface of a stack of sheets S. In addition, the sheet feed roller 74 is located at a predetermined position, that is, a position where the sheet feed roller 74 conveys the sheet S fed by the pick roller 72. The sheet feed roller 74 and the sorting roller 76 are disposed at positions where the sheet feed roller 74 and the sorting roller 76 form a nip. Note that, the pick holder 54 is exposed to the outside by opening a cover of the right side surface 3b of the apparatus main body 3 and tilting the conveyance guide 73 to the outside. The pick holder 54 is configured such that the pick roller unit 70 is insertable into and pullable from the side of the right side surface 3b of the apparatus main body 3.

The pick holder 54 is connected to the conveyance guide 73 via the biasing member 734. By pivoting the conveyance guide 73 to the right side such that the inside of the sheet feed mechanism 7 is exposed to the outside, the conveyance guide 73 pulls the biasing member 734 as illustrated in FIG. 8. Thus, the swing arm 542 swings via the biasing member 734, and the pick roller 72 moves.

That is, when the pick roller unit 70 is detached from the apparatus main body 3, the leading end of the conveyance guide 73 is pivoted around a shaft 732 to the right side, that is, in a direction in which the leading end is separated from the apparatus main body 3. By this pivoting, a state is reached in which the pick roller 72 is separated from the abutting position with the sheet S and is disposed in the first supporter 702, and the pick roller unit 70 itself is removable to the right side, that is, to the side of the conveyance direction.

As described above, when the pick roller 72, the sheet feed roller 74, and the sorting roller 76 are located at the positions at the time of sheet passing, the pick roller 72 is located at the pressing position in contact with the sheet S in order to convey the sheet S. At the pressing position, the pick roller 72 interferes with a sheet feed cassette including the tray 52A when the pick roller 72 is removed, whereas the pick roller 72 when located at the separated position does not interfere therewith.

Note that, after the pick roller unit 70 is detached from the apparatus main body 3, the rotation shafts 722 and 742 of the pick roller 72 and the sheet feed roller 74 can be pulled out from the respective roller main bodies as illustrated in FIG. 6. Accordingly, these components can be easily replaced.

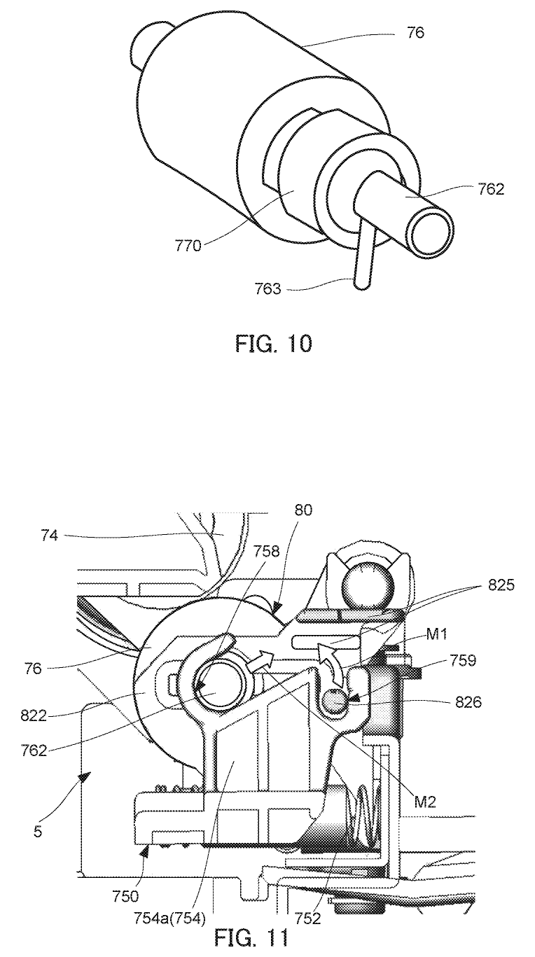

FIG. 9 is a perspective view of the sorting unit illustrated in FIG. 4, and FIG. 10 is a perspective view of a sorting roller through which a rotation shaft is inserted.

In the sorting unit 80, the sorting roller 76 is attachable to and detachable from a side (the side of the right side surface 3b) of the apparatus main body 3.

As illustrated in FIGS. 4 and 7, the sorting unit 80 is held by a sorting holder 750 of the apparatus main body 3. The sorting unit 80 is pressed against the sheet feed roller 74 (in the direction indicated by the arrow in FIG. 4) by the sorting holder 750 via a biasing member 752 such as a compression spring.

The sorting unit 80 includes the sorting roller 76 and a unit main body 82 that pivotably supports the sorting roller 76.

In the sorting unit 80, the sorting roller 76 is provided to be attachable to and detachable from the unit main body 82 via a rotation shaft 762 concentric with the sorting roller 76. The sorting roller 76 is inserted through the rotation shaft 762, and the rotation shaft 762 is provided with a torque limiter 770.

The unit main body 82 is provided to be insertable into and pullable from the apparatus main body 3 and includes a main body wall 821 that is disposed to face the sorting roller 76, and a support wall 822 is provided in parallel with and orthogonal to both sides of the main body wall 821. The unit main body 82 is constituted by a designated color different from that of other components. Thus, when the sorting roller 76 is replaced, the identification of a replacement component is facilitated and simplifying of the replacement work can be achieved.

The rotation shaft 762 is attached so as to be provided between the support walls 822, and the sorting roller 76 is held together with the torque limiter between the support walls 822.

Parallel pins 763 orthogonal to each other are provided at one end of the rotation shaft 762.

In addition to a hole 824 through which the rotation shaft 762 is inserted, a guide (handle) 825 having a rib shape which extends in the extending direction and also serves as a handle and a guiding boss (protrusion) 826 are provided in a part of the support wall 822, for example, in a joined portion thereof to the main body wall 821. In addition, a slit 83 through which the parallel pin 763 can be inserted is formed in one of the support walls 822. The main body wall 821 is provided with a guide (handle) 8255 vertically protruding and having a rib shape.

After the sorting unit 80 is replaced, only the sorting roller 76 is replaced and reused. For this reason, the unit main body 82 includes the slit 83 for a parallel pin, which is used when the rotation shaft 762 is pulled out for the replacement of the sorting roller 76. That is, at the time of sheet passing, the sorting roller 76 rotates counterclockwise in FIGS. 9 and 10 (printing rotation), and thus, the parallel pin 763 follows the rotation of the rotation shaft 762, interferes with a protrusion (not illustrated) of the main body wall 821, and is locked.

At the time of replacing the sorting roller 76, since the sorting roller 76 rotates in the clockwise direction opposite to that at the time of sheet passing (during printing), the rotation shaft 762 rotates getting over the protrusion at the lock position, and the slit 83 and the parallel pin 763 become parallel to each other to pull out the rotation shaft 762 from the unit main body 82. Thus, the rotation shaft 762 is pulled out together with the torque limiter 770 from the sorting roller 76 as well, and the sorting roller 76 can be detached from the unit main body 82. Thereafter, the sorting roller 76 itself is replaced.

The rotation shaft 762 rotates in a direction opposite to that of the sheet feed roller 74 at the nip.

The torque limiter 770 regulates the rotation of the sorting roller 76 and controls torque generated by the rotation of the sheet feed roller. In a case where only one sheet S is held at the nip between the sheet feed roller 74 and the sorting roller 76, load torque applied to the sorting roller 76 increases, the sorting roller 76 rotates together with the sheet S, and the sheet S is fed to the image former via a conveyance path.

FIG. 11 is a side view of the sorting holder to which the sorting unit is attached.

The sorting holder 750 includes: the biasing member 752, such as a compression spring, for pressing the sorting roller 76 against the sheet feed roller 74; and the unit main body 754 that is provided such that the unit main body 754 is movable to the side of the sheet feed roller 74, and that holds the sorting unit 80.

The unit main body 754 includes both side walls 754a which are provided to extend in a direction orthogonal to the conveyance direction and which hold the sorting unit 80 from the both sides in the shaft direction of the sorting roller 76.

In each of the both side walls 754a, a first U-shaped groove 758 which engages with the rotation shaft 762 and a second U-shaped groove 759 with which a guiding boss 826 engages are formed.

The first U-shaped groove 758 is formed so as to be inclined upward and is opened to the side of the conveyance guide 73, and is engaged with the rotation shaft 762 in a state in which the rotation shaft 762 has moved downward. The first U-shaped groove 758 engages with the rotation shaft 762 to position the sorting roller 76. The second U-shaped groove 759 is formed in a shape cut out in a direction continuously intersecting the inclined portion of the first U-shaped groove 758.

The second U-shaped groove 759 opens upward and is continuous with the first U-shaped groove 758.

The sorting holder 750 biases the unit main body 754 to the side of the sheet feed roller 74 via the biasing member 752. The sorting holder 750 presses the sheet feed roller 74 with the sorting roller 76 held by the unit main body 754 via the biasing member 752 to locate the sheet feed roller 74 at the nipping position.

The biasing member 752 is interposed between the unit main body 754 and the conveyance guide 73. When the conveyance guide 73 is in the closed state, that is, when the leading end of the conveyance guide 73 is close to the right side surface 3b, the unit main body 754 is pressed to the side of the sheet feed roller 74.

### Removal of Sorting Unit

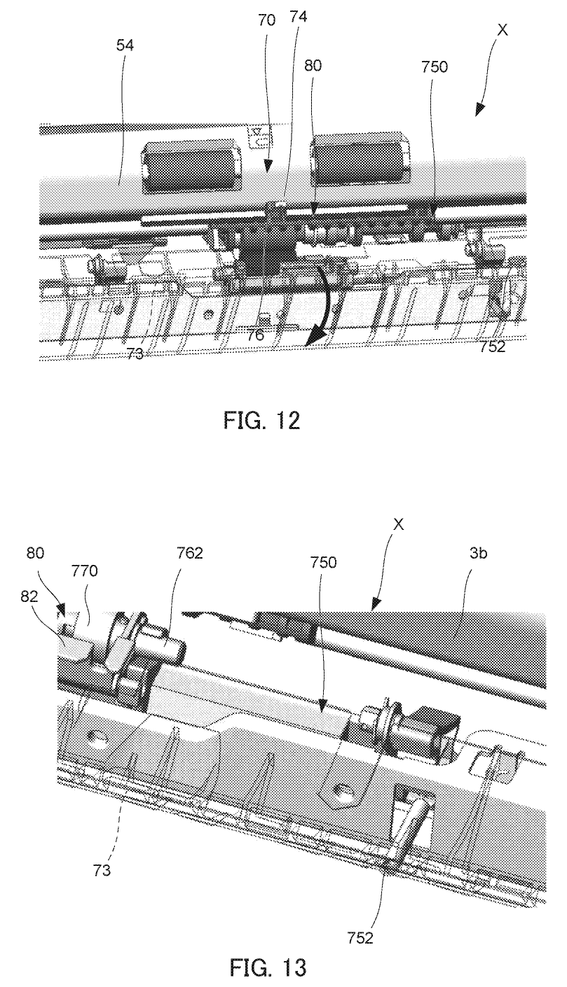

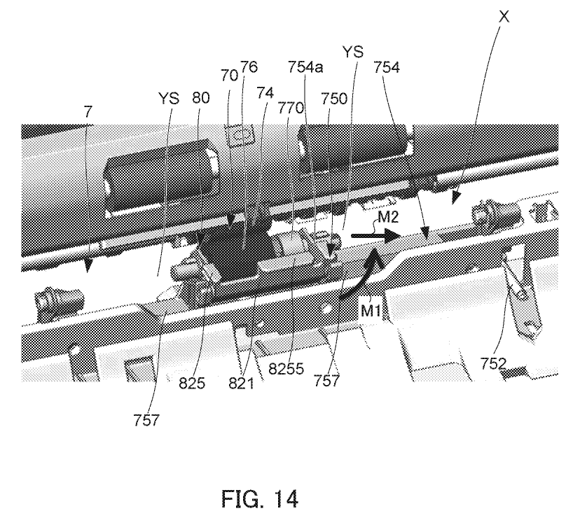

FIG. 12 is a diagram illustrating the sheet feed mechanism including the pick roller unit and the sorting unit with a cover removed at the X portion in FIG. 1. FIG. 13 is an enlarged view of the sorting holder to which the sorting unit is attached in FIGS. 12, and 14 is a perspective view of the sorting unit in a replaceable state in the X portion of FIG. 1.

The biasing member 752 which is a tension spring is attached between the conveyance guide 73 and the sorting holder 750. Thus, as illustrated in FIG. 12, the conveyance guide 73 is opened, that is, the leading end of the conveyance guide 73 is inclined to the right side.

Thus, the sorting holder 750 is pulled to the side of the conveyance guide 73 via the biasing member 752, and the sorting holder 750 is separated from the sheet feed roller 74. Along with the movement of the sorting holder 750, the sorting roller 76 that has pressed the sheet feed roller 74 moves to the side of the right side surface 3b and is separated from the sheet feed roller 74. The sorting roller 76 is switched between the separated state and the pressure contact state with respect to the sheet feed roller 74 in response to the movement of the conveyance guide 73.

That is, the sorting roller 76 is configured to be detachable, after the pressure contact state between the sorting roller 76 and the sheet feed roller 74 is released, along the conveyance direction and in a direction different from the direction in which the pressure contact is released. In this state, as illustrated in FIG. 13, the sorting unit 80 and the sorting holder 750 are exposed to the outside. Note that, in this state, the sorting roller 76 can be removed by pulling out the rotation shaft 762 in the shaft direction, that is, in the depth direction in a state in which the sorting unit 80 is attached to the sorting holder 750.

Then, the sorting unit 80 held by the sorting holder 750 located at a position separated from the sheet feed roller 74 is removed from the apparatus main body 3.

As illustrated in FIGS. 11 and 14, the guides (handles) 825 and 8255 having a handle shape in the sorting unit 80 are lifted from the side of the right side surface 3b of the apparatus main body 3 and are pulled toward the front. Specifically, the guide 825 and the guiding boss 826 in the sorting unit 80 are moved upward, and the guiding boss 826 is pivoted in an M1 direction around the rotation shaft 762 to be removed from the second U-shaped groove 759.

In such a state, the guides 825 and 8255 are pulled in a direction in which the guides 825 and 8255 are separated from the apparatus main body 3, that is, to the right side of the apparatus main body 3 which is an M2 direction to pull out the sorting unit 80 to the outside.

Thus, it is possible to remove the sorting unit 80 from the sorting holder 750 and replace the sorting unit 80.

In addition, in the apparatus main body 3, as illustrated in FIG. 14, a draw-shaped portion 757 is provided at a frame of the unit main body 754 of the sorting holder 750 such that a finger is easily put onto the outer side of the sorting unit 80 at the time of replacement. That is, the apparatus main body 3 includes the draw-shaped portion (cutout) 757 that communicates the sorting roller 76 of the sorting unit 80 attached to the sorting holder 750 and both end-side regions of the sorting roller 76 in the shaft direction with the outside.

In the image forming apparatus 1, in a case where a plurality of sheets S is held at the nip, the sorting roller 76 rotates in a direction opposite to that of the sheet feed roller, and thus, only the topmost sheet is fed to the image former.

In the image forming apparatus 1 having such a structure, the sorting roller 76 is worn out or deteriorates over time, and therefore requires periodic maintenance and inspection as well as periodic replacement.

According to the sheet feed apparatus 5 of the image forming apparatus 1, it is not necessary to pull out each of the sheet feed cassettes including the trays 52A to 52D. When the right door (the apparatus cover 3d on the right side) is opened and the conveyance guide 73 is opened, the sorting roller 76 is separated from the sheet feed roller 74 in conjunction therewith, and the sorting roller 76 is in a replaceable state. In this state, the sorting unit 80 can be pulled out from the sorting holder 750 the apparatus main body 3 at a position where the sorting roller 76 can be surely visually inspected.

Unlike the related art, when replacing the sorting roller 76, it is not necessary to replace the sorting roller 76 while performing the separation in a direction opposite to that of the pressing against the sheet feed roller 74 with one hand.

As described above, according to the image forming apparatus 1, a rotator such as a sorting roller can be easily and suitably replaced.

In addition, simply by opening the conveyance guide 73, the pick roller 72 in also in a replaceable state together with the pick roller unit 70, and the pick roller 72 can be easily replaced by pulling out the pick roller unit 70 from the right side of the apparatus main body 3.

The conveyance guide 73 is opened not at the front surface of the image forming apparatus 1 but from the right door thereof, the pressing of the sorting roller 76 against the sheet feed roller 74 is released in conjunction with the opening of the conveyance guide 73, and the sorting unit 80 including the sorting roller 74 can be replaced.

In addition, the configuration makes it possible to perform a check by opening the right door, involves high visibility, facilitates the roller replacement work, and enables even a user to replace a roller. In addition, work time is also shortened when the replacement is performed by a service person.

It should be understood that the embodiment disclosed herein is illustrative and non-restrictive in any respect. The scope of the present invention is defined not by the above description but by the appended claims, and is intended to include any modifications within the scope and meaning equivalent to the appended claims.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus, comprising:
a first rotator; and
a second rotator that comes into pressure contact with the first rotator, the second rotator and the first rotator holding a recording medium between the second rotator and the first rotator to convey the recording medium, wherein
the first rotator is detachable, after a pressure contact state between the first rotator and the second rotator is released, to a conveyance side and in a direction different from a direction in which the pressure contact is released.

2. The image forming apparatus according to claim 1, wherein:
the first rotator is a sorting roller,
the second rotator is a sheet feed roller, and
the image forming apparatus further comprises:
a nip at which the sorting roller and the sheet feed roller feed the recording medium; and
a conveyor that conveys the recording medium fed from the nip downstream, wherein:
the conveyor includes an outside conveyor and a main body-side conveyor, the outside conveyor being opened to an outside, the main body-side conveyor remaining on a side of an apparatus main body even when the outside conveyor is opened to the outside, and
the outside conveyor moves so as to be separated from the main body-side conveyor and is opened to the outside to release the pressure contact state between the sorting roller and the sheet feed roller.

3. The image forming apparatus according to claim 2, wherein
the main body-side conveyor is provided to be attachable to and detachable from the apparatus main body by a user operation.

4. The image forming apparatus according to claim 2, wherein
the outside conveyor is opened to the outside by pivoting.

5. The image forming apparatus according to claim 2, wherein
the sorting roller and the sheet feed roller are located on an upstream side of the main body-side conveyor.

6. The image forming apparatus according to claim 2, wherein:
each of the sorting roller and the sheet feed roller is disposed in the apparatus main body,
the sorting roller forms a sorting unit together with a supporter, a rotation shaft, and a torque limiter, the supporter holding the sorting roller, the rotation shaft being concentric with the sorting roller, the torque limiter separating a sheet, and
the sorting unit is attachable to and detachable from the apparatus main body on the conveyance side and in the direction different from the direction in which the pressure contact is released.

7. The image forming apparatus according to claim 6, wherein
the supporter includes a handle.

8. The image forming apparatus according to claim 6, further comprising
a sorting holder that is disposed in the apparatus main body and holds the sorting unit, in a state in which the sorting unit is positioned, such that the sorting unit is attachable and detachable, wherein:
the sorting holder includes: a first groove having a U shape, the first groove engaging with the rotation shaft to position the sorting roller; and
a second groove having a U shape, the second groove engaging with a guiding protrusion provided at the supporter to regulate rotation of the sorting unit around the rotation shaft.

9. The image forming apparatus according to claim 8, wherein:
the sorting holder includes a biasing member that presses the sorting roller against the sheet feed roller, the biasing member coupling one end of the sorting holder to one end of the outside conveyor, and
the sorting roller is switched between a separated state and the pressure contact state with respect to the sheet feed roller in response to movement of the outside conveyor.

10. The image forming apparatus according to claim 6, wherein
a part of the supporter includes: a protrusion that engages with a pin coupled to the rotation shaft during printing to regulate rotation of the rotation shaft, and
a groove through which the pin is insertable after engagement with the projection is released when the rotation shaft is moved in a shaft direction by rotating in a direction opposite to a printing rotation, the groove being a groove.

11. The image forming apparatus according to claim 1, further comprising
first-stage to fourth-stage suppliers of the recording medium, each of the first-stage to fourth-stage suppliers including the first rotator and the second rotator.

12. The image forming apparatus according to claim 6, wherein
the apparatus main body includes a cutout that communicates the sorting roller of the sorting unit and both end-side regions of the sorting roller with the outside, the sorting unit being attached to the sorting holder.

13. The image forming apparatus according to claim 6, wherein
the sorting unit has a color that indicates replaceability and is different from a color of another component.

14. The image forming apparatus according to claim 2, further comprising
a pick roller that abuts on the recording medium and conveys the recording medium to the nip, wherein
the pick roller is separated from the recording medium in conjunction with movement of the outside conveyor.

15. The image forming apparatus according to claim 14, further comprising
a pick holder that supports the pick roller such that the pick roller is movable between a conveyance position and a separated position during supply of the recording medium, the conveyance position being a position where the pick roller is lowered to a position where the pick roller comes into contact with the recording medium, the separated position being a position where the pick roller is separated from the recording medium, wherein:
the pick holder is biased to the conveyance position by a biasing member that couples one end of an arm of the sheet feed roller to one end of the outside conveyor, the arm rotating around a shaft of the sheet feed roller, and
the pick holder moves to the separated position by the outside conveyor moving and being separated from the main body-side conveyor.

16. The image forming apparatus according to claim 14, wherein:
the pick roller and the sheet feed roller are disposed inside a frame-shaped supporter and form an integral pick roller unit that is pivotably supported by the frame-shaped supporter via each of a rotation shaft of the pick roller and a rotation shaft of the sheet feed roller, and
each of the rotation shaft of the pick roller and the rotation shaft of the sheet feed roller is provided in the frame-shaped supporter to be insertable into and pullable from the frame-shaped supporter.
